(19) United States
(12) Patent Application Publication
(10) Pub. No.: US 2026/0177985 A1
(43) Pub. Date: Jun. 25, 2026

(54) MOVEMENT COMPRISING A STRIKING DEVICE

(71) Applicant: Montres Breguet S.A., L'Abbaye (CH)

(72) Inventors: Jean-Jacques BORN, Morges (CH); Jérôme FAVRE, Neuchâtel (CH)

(73) Assignee: Montres Breguet S.A., L'Abbaye (CH)

(21) Appl. No.: 19/407,499

(22) Filed: Dec. 3, 2025

(30) Foreign Application Priority Data
Dec. 20, 2024 (EP) 24222500.1

(51) Int. Cl. G04B 21/06

(52) U.S. Cl. CPC G04B 21/06

(57) ABSTRACT

A horology movement includes a striking device (4) including an anti-bounce device (5) arranged so that each strike of the gong (10) by the hammer (6) is followed by a single bounce which is partial, such that the hammer does not touch the vibrating gong as a result of the strike, so as not to impair the quality of the sound produced by the strike.

### Cross Reference to Related Applications

This application claims priority to European Patent Application No. 24222500.1, filed on December 20, 2024, the entire contents of which are incorporated herein by reference.

### Technical field of the invention

The present invention relates to a horology movement comprising a striking device, which is conventionally formed by a hammer, a gong, a spring for driving the body of the hammer to perform each strike, and a hammer actuating mechanism for winding the hammer before each strike.

### Technological background

Horology movements comprising striking devices have been known for a long time. This is a horological complication that requires a great deal of horology expertise. A common technical problem is damping the hammer after a strike, to decrease the number of bounces and their amplitude. But irrespective of the known solution, even a single bounce with a relatively low amplitude creates a problem because such a bounce quickly disrupts the resonating/vibrating gong. In particular, a full bounce can muffle the sound emitted by a strike, especially if the striking beak comes into contact with the gong again with a phase shift relative to the transverse movement of the vibrating gong. This can be heard by the user and is detrimental to the sound quality of the gong and the intensity of the sound emitted.

To damp the hammer after the strike and limit the bounces, a conventional striking device comprises a counter-spring which, as its name indicates, acts on the hammer, in a terminal phase of its travel towards the gong, to brake the hammer strongly enough to oppose its movement towards the gong generated by a drive spring. This counter-spring is designed with a high degree of stiffness and is arranged so that the terminal phase is fairly short, so as not to decrease the kinetic energy of the hammer too much before it strikes the gong. However, the counter-spring has to act early enough on the hammer to avoid multiple bounces and, ideally, to have a single, partial bounce if possible. It should be noted that the counter-spring defines the hammer's lock position, which leaves the beak relatively close to the gong without touching it, whether it is vibrating or not. As a result, fitting and adjusting the configuration of the counter-spring in the striking device is a difficult and time-consuming operation, even for an experienced horologist.

Another major drawback of the counter-spring is that it decreases the amount of energy that can be transmitted to the gong by the hammer by strongly opposing the movement of the hammer in the terminal phase. This mechanical energy loss therefore lowers the performance of the striking device, which loses a certain amount of mechanical energy before each strike.

In this text, the term “strike” is taken to mean the brief moment in which the hammer comes up against the gong, generally close to its anchoring, after it has been wound, and during which the body of the hammer excites the gong by transmitting a certain amount of mechanical energy to it. The term “bounce” is taken to mean a return movement of the body of the hammer after a strike, followed by a movement in which the body moves back towards the gong until it touches it again. “Partial bounce” is therefore taken to mean a bounce by the body of the hammer that displays a return movement, but does not then come back into contact with the gong because it is stopped before such an event can occur.

### Summary of the invention

The invention aims to provide a solution to the aforementioned problems of the prior art. In particular, the invention aims to provide a horology movement fitted with a striking device in which the hammer performs a single, partial bounce, that is to say no full bounce, after a strike, without braking the body of the hammer as it travels between an end position (hammer in a loaded state) and the contact position with the gong (position in which the striking beak comes into contact with the gong when striking), and consuming little mechanical energy, preferably virtually no energy, from the energy source associated with the striking device. It is therefore designed to provide a striking device capable of achieving maximum efficiency between the mechanical energy provided to the hammer actuating mechanism, which winds this hammer before each strike, and the energy transmitted by the hammer to the gong, while at the same time making it possible to obtain a very high sound quality from the gong and in particular a gong vibration that is not damped by a bounce.

To this end, the invention relates to a movement incorporating a striking device that comprises a gong, a hammer fitted so as to be rotationally mobile around a first axis of rotation and a spring for rotationally driving the hammer. The hammer has a body with a striking beak arranged in a zone at a distance from the first axis of rotation, and the drive spring is arranged to be able to apply a driving force to the body of the hammer so as to cause it to rotate in a first direction that brings the striking beak closer to the gong and allows the striking beak to strike the gong, The striking device comprises a hammer actuating mechanism for winding the hammer from a lock position of the body of the hammer, in which the striking beak is separated from the gong, by rotating this body in a second direction, opposite to the first direction, to an end position of said body, so as to load the drive spring, and then to release the hammer so that it can strike the gong under the action of the driving force; A remarkable feature of the striking device is that it comprises an anti-bounce device arranged so that it can be alternately:

in a first configuration, in which the anti-bounce device stops the body of the hammer from moving in the first direction of rotation, starting at least at a first intermediate position between the lock position and the end position of this body, before the striking beak can touch the gong, whether the latter is vibrating or not, and

in a second configuration, different from the first configuration, in which the anti-bounce device does not stop the hammer from rotating in the first direction of rotation between the end position of said body and a contact position, at which the striking beak reaches the gong, provided that the anti-bounce device is in this second configuration when said body shifts through a second intermediate position between the lock position and the end position; the anti-bounce device does not brake the body of the hammer at least between the second intermediate position and the contact position, preferably between the end position and the contact position.

The striking device is arranged such that, directly after each strike, the body of the hammer is subjected to a return movement, rising at least to the first intermediate position without reaching the end position. This striking device is arranged such that the anti-bounce device is:

kept in the first configuration when the hammer is locked and said body is therefore in the lock position;

brought into the second configuration each time the hammer is wound by the actuating mechanism or after the hammer is released before the body of this hammer reaches the second intermediate position;

then returned to the first configuration during the return movement of said body; and

then remains in the first configuration until the hammer is locked again or wound again by the actuating mechanism;

said body thus being subjected to a single, partial bounce after each strike.

In a main embodiment, the anti-bounce device comprises an anti-bounce part fitted so as to be rotationally mobile on the body of the hammer around a second axis of rotation, and a first stop fitted on a support on the hammer and arranged such that:

when the anti-bounce part is, when said body shifts through the second intermediate position, in a second position or second range of positions relative to the body of the hammer and the anti-bounce device is thus in the second configuration, the anti-bounce part does not contact the first stop when said body rotates between the end position and the contact position;

when the anti-bounce part is in a first position or first range of positions relative to the body of the hammer and the anti-bounce device is thus in the first configuration, the body of the hammer is stopped by the anti-bounce part coming up against the first stop when rotating in said first direction starting at least at the first intermediate position and before the end position; and

when the hammer is locked, the anti-bounce part presses against the first stop.

In a general embodiment, the anti-bounce part has a centre of mass which is at a distance from the second axis of rotation, and has a contact surface with the first stop, this contact surface being configured to stop the body of the hammer when the anti-bounce device is in the first configuration, when the body is rotating in said first direction, starting from at least the first intermediate position, by coming up against the first stop and to keep said body in the lock position when the hammer is locked.

In a first embodiment, the anti-bounce device is arranged such that the shift of the anti-bounce part from said first position or range of positions to said second position or range of positions occurs while the hammer is wound by the actuating mechanism, when said body is rotating between a maximum position for said return movement and the end position.

In a second embodiment, the anti-bounce device is arranged so that the shift of the anti-bounce part from said first position or first range of positions to said second position or second range of positions occurs after the hammer has been released and before the body of this hammer reaches the second intermediate position. The anti-bounce part is arranged such that, in the first position or first range of positions, said centre of mass is at a distance from a geometric straight line running through the second axis of rotation and orthogonal to a straight line connecting the first axis of rotation and the second axis of rotation, the anti-bounce part being subjected, relative to said body, to a first apparent force couple due to an acceleration to which said body is subjected, and thus the anti-bounce part at the second axis of rotation, generated by said driving force applied to this body by the drive spring The anti-bounce device is arranged such that the first apparent force couple causes the anti-bounce part to rotate to the second position or second range of positions and remains in this second position or second range of positions until said contact surface of the anti-bounce part has moved beyond the first stop during said rotation of said body between the end position and the contact position.

In an advantageous embodiment, the shift of the anti-bounce part from said second position or second range of positions to said first position or first range of positions is released by the strike of the gong by the body of the hammer, the anti-bounce part being arranged such that, in the second position or second range of positions, said centre of mass is at a distance from a geometric straight line running through the second axis of rotation and orthogonal to a straight line connecting the first axis of rotation and the second axis of rotation, the anti-bounce part being subjected relative to said body to a second apparent force couple due to a reaction force from the gong to which that body is subjected, and thus the anti-bounce part at the second axis of rotation, when the striking beak stops against the gong, the anti-bounce device being arranged such that the second apparent force couple causes the anti-bounce part to rotate to the first position or range of positions in which it remains during said return movement of said body.

### Brief Description of the figures

The invention will be described in greater detail below with reference to the appended drawings, which are given by way of non-limiting examples, in which:

FIG. 1 shows a partial plan view of a horology movement fitted with a striking device according to a first embodiment of the invention;

FIGS. 2a to 2h show various successive states of the striking device in FIG. 1 when the hammer is wound, followed by a strike on the gong, until the hammer returns to its locked state;

FIG. 3 shows a partial plan view of a horology movement fitted with a striking device according to a second embodiment of the invention;

FIGS. 4a to 4g show various successive states of the striking device in FIG. 3 when the hammer is wound, followed by a strike on the gong, until the hammer returns to its locked state, corresponding to the state shown in FIG. 3;

FIG. 5 is a schematic representation of the various phases involved in the process of generating a strike on the gong and the single partial bounce following the strike;

FIGS. 6, 7 and 8 show three variants of the first embodiment.

### DETAILED DESCRIPTION OF THE INVENTION

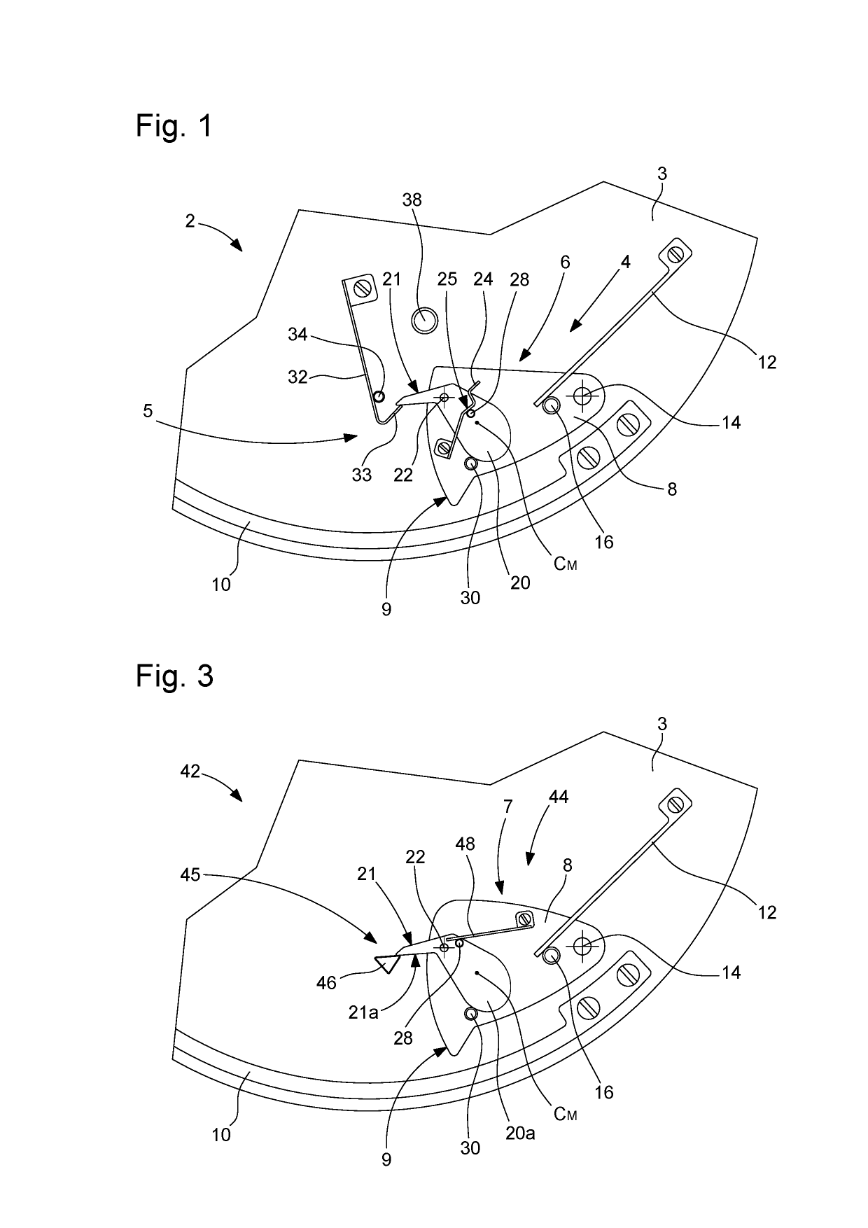

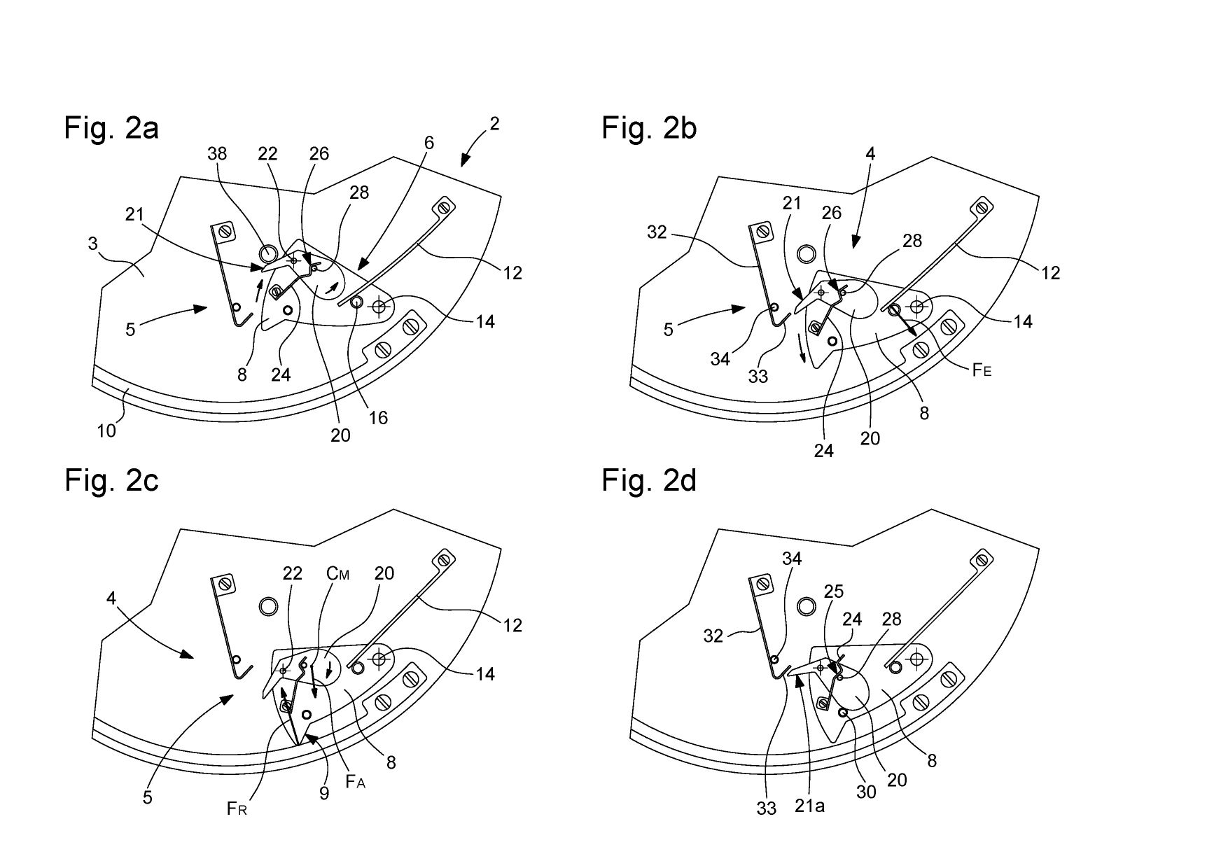

With reference to FIGS. 1 and 2a to 2h, a first embodiment of a horology movement according to the invention will be described hereinafter. First, a main embodiment of the invention will be described, covering the first embodiment and the second embodiment, which will subsequently be described in detail, with reference to FIGS. 1 to 2h, which relate to the first embodiment (for the clarity of the description, which will present the second embodiment only after the first). The main embodiment is a preferred embodiment within the general scope of the invention defined by the general characteristics of claim 1, which are set out hereinafter also with references to the figures relating to the first embodiment (for the sake of clarity).

In general, the movement 2 incorporates a striking device 4 comprising a gong 10, a hammer 6 fitted so as to be rotationally mobile around a first axis of rotation 14 and a spring 12 for rotationally driving the hammer. The hammer 6 has a body 8 with a striking beak 9 arranged in a zone at a distance from the first axis of rotation 14. The striking device 4 conventionally comprises a hammer actuating mechanism for winding the hammer from a lock position (FIG. 1) of the body of the hammer, in which the striking beak 9 is separated from the gong 10, by rotating this body in a second direction, opposite to the first direction, to an end position (FIG. 2a) of said body, so as to load the drive spring 12, and then to release the hammer so that this hammer can strike the gong under the action of the driving force; It should be noted that the actuating mechanism is not shown in the figures. The drive spring 12 is arranged so as to be able to apply a driving force F_{E} to the body 8 of the hammer 6, for example by pressing against a pin 16 fastened to the body, so as to rotate the body 8 in a first direction that brings the striking beak 9 closer to the gong 10 (FIG. 2b) and allows this gong to be struck by the striking beak (FIG. 2c).

According to the invention, the striking device 4 generally comprises an anti-bounce device 5, which will be described in detail hereinafter, arranged so that it can alternatively be:

in a first configuration (shown in particular in FIGS. 2f, 2g, 2h), in which the anti-bounce 5 device stops the body 8 of the hammer 6 from moving in the first direction of rotation, starting at least at a first intermediate position (substantially FIG. 2g) between the lock position (FIG. 1) and the end position (FIG. 2a) of this body, before the striking beak 9 can touch the gong 10, whether the latter is vibrating or not; and

in a second configuration (shown in particular in FIGS. 2a and 2b), different from the first configuration, in which the anti-bounce device 5 does not stop the hammer 6 from rotating in the first direction of rotation between the end position and a contact position on the body 8 at which the striking beak reaches the gong 10 (FIG. 2c), provided that the anti-bounce device is in this second configuration when the body 8 shifts through a second intermediate position (substantially FIG. 2b) located between the lock position and the end position; the anti-bounce device 5 does not brake the body 8 of the hammer 6 at least between the second intermediate position and the contact position, preferably between the end position and the contact position.

The striking device 4 is arranged such that, after each strike, the body 8 of the hammer 6 is subjected to a return movement (FIGS. 2d, 2e), rising at least to the first intermediate position without reaching the end position. It should be noted that the body never reaches the end position during the return movement, as it transmits a significant part of its mechanical energy to the gong during the strike. Moreover, the striking device is arranged such that the anti-bounce device 5 is:

kept in the first configuration when the hammer 6 is locked and the body 8 is therefore in the lock position;

brought into the second configuration, each time the hammer is wound by the actuating mechanism (first embodiment) or after the hammer is released before the body 8 of this hammer reaches the second intermediate position (second embodiment to be described in detail subsequently);

then returned to the first configuration during said return movement of said body 8; and

then remains in the first configuration until the hammer is locked again or wound again by the actuating mechanism.

Due to the general characteristics of the invention, the body 8 is subjected to a single bounce, which is partial, after each strike. This is a highly remarkable result, and the main characteristics for achieving it are described below.

In the main embodiment, encompassing the first embodiment and the second embodiment (the latter will be described in more detail later and references to the figures for this second embodiment are not given here so as not to detract from the clarity of the presentation), the anti-bounce device 5 comprises an anti-bounce part 20, fitted so as to be rotationally mobile on the body 8 of the hammer 6 around a second axis of rotation 22, and a first stop 33 fitted on a support on the hammer (plate 3 in the figures) and arranged such that:

when the anti-bounce part 20 is, when said body 8 of the hammer 6 shifts through the second intermediate position (FIG. 2b), in a second position (FIGS. 2a to 2c) or second range of positions relative to said body 8 and the anti-bounce device 5 is thus in the second configuration, the anti-bounce part 20 does not contact the first stop 33 when said body 8 rotates between the end position (FIG. 2a) and the contact position (FIG. 2c);

when the anti-bounce part 20 is in a first position (FIGS. 2f to 2h)or first range of positions relative to the body 8 of the hammer and the anti-bounce device 5 is thus in the first configuration, the body 8 of the hammer 6 is stopped by the anti-bounce part 20 coming up against the first stop 33 when rotating in said first direction starting at least at the first intermediate position (FIG. 2g) and below the end position; and

when the hammer 6 is locked, the anti-bounce part 20 presses against the first stop 33.

The main embodiment is further characterised in that the anti-bounce device 5 comprises a flexible element 24 which is fastened to the body 8 of the hammer 6 and arranged to interact with the anti-bounce part 20.

In a first main variant of the first embodiment of a horology movement 2 according to the invention, the flexible element 24 of the anti-bounce device 5 is fastened to the body 8 and comprises a portion defining a recess 26 with a non-tangential orientation relative to the second axis of rotation 22 and preferably angularly closer to a radial straight line running through a point at the back of the recess than to a tangential straight line running through this point. The recess 26 defines a stable position for the anti-bounce part 20, which comprises a pin 28 that forms a support part for the flexible element, this pin having an axial surface against which the flexible element can press. In one variant, the support part can be a protruding part integral with the base plate forming the anti-bounce part. In another variant, the support part can be part of the base plate, on which a lateral surface defines an axial support surface for the flexible element, which is thus arranged in the same general plane as the base plate.

The pin 28 is arranged so as to be able to be turned in at least partially in the recess 26, substantially without slack when the anti-bounce part 20 is in said stable position defined by this recess, and to be able to elastically displace said portion of the flexible element, under the action of a force couple to which the anti-bounce part may be subjected, in order to exit the recess. In fact, in two specific phases in the process of generating a sound by the striking device 4, a force couple is applied to the anti-bounce part with an intensity allowing a shift of this anti-bounce part respectively from said first position or first range of positions to said second position or second range of positions and a reverse shift. It should be noted that the force couple has a direction for the reverse shift which is opposite to the direction of this force couple during the aforementioned shift. It should also be noted that the intensity of the force couple generally differs according to its direction in the sound generation process. The orientation of the recess 26 is generally defined by a median straight line between its two flanks, which rise from the back of the recess.

In the variant shown in the figures, the flexible element 24 is formed by a spring wire extending in a geometric plane and it has a first substantially straight resilient part and a second part, on the side of its free end, with bends followed by oblique segments, this second part thus being less resilient than the first part. In particular, the recess 26 has a V shape defined by two oblique segments of the spring wire. In the first main variant, the anti-bounce part is in said first position or said second position when it is in said stable position defined by the recess in the flexible element. Then, said portion of the flexible element is configured such that, when the recess defines the first position, the anti-bounce part 20 can be actuated in the second position or second range of positions under the action of said force couple and, when the recess defines the second position, the anti-bounce part can be actuated in the first position or first range of positions under the action of said force couple. In the variant shown in the figures, the recess 26 defines said second position.

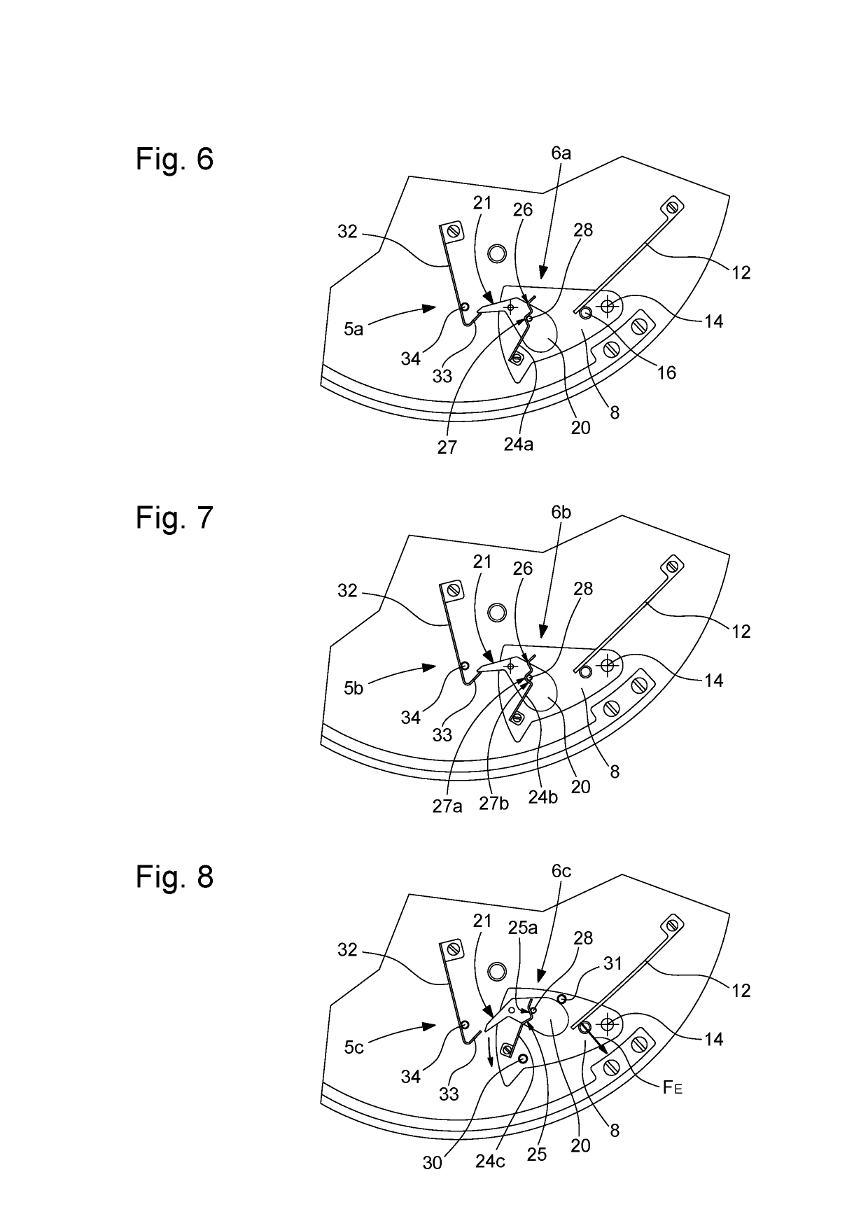

Two variations will be described below. In a first particular variant shown in FIG. 6, said portion of the flexible element is a first portion and said recess 26 is a first recess. In the anti-bounce device 5a, the flexible element 24a, fitted to the body 8 of the hammer 7, comprises a second portion defining a second recess 27 with a non-tangential orientation relative to the second axis of rotation 22, preferably angularly closer to a radial straight line running through a point at the back of the second recess than to a tangential straight line running through this point. The second recess 27 defines a second stable position for the anti-bounce part, the flexible element 24a being arranged such that the pin 28 can be at least partially turned in the second recess, substantially without slack when the anti-bounce part 20 is in the second stable position, and can elastically move the second portion of the flexible element under the action of a second force couple, opposite to said force couple, to which the anti-bounce part can be subjected to exit the second recess 27. The first recess 26 defines the first position of the anti-bounce part and the second recess 27 defines the second position of this anti-bounce part when the pin 28 is turned in alternately in the first recess 26 and in the second recess 27. The second portion of the flexible element is configured such that the anti-bounce part 20 can be brought into the first position under the action of the second force couple. As already mentioned, the first force couple and the second force couple appear during the process of generating a sound by the striking device of the invention.

In a second particular variant of the anti-bounce device 5b, shown in FIG. 7, the flexible element 24b comprises a recess 27a which is configured such that it has a flank 27b forming a stop for the pin 28, in a direction of rotation of the anti-bounce part which is opposite to the direction of rotation for moving the anti-bounce part 20, when the recess 27a defines the first position or first range of positions, in the second position or second range of positions (general case) or alternatively, when the recess defines the second position or second range of positions, in the first position or first range of positions. This stop flank 27b limits the angular travel of the anti-bounce part 20 by opposing the force couple that brings the pin 28 into the recess during a shift from one position of the anti-bounce part to the other. This variant makes it possible to avoid having to add a pin or other protruding part to the body 8 of the hammer 6b to stop the anti-bounce part in its rotation under the action of said force couple that causes the anti-bounce part to shift from the second position to the first position, and this force couple can be very high. This first variant is therefore particularly advantageous when the recess defines the first position of the anti-bounce part, as shown in FIG. 7.

In a second main variant, the anti-bounce device comprises a flexible element 24 which is fastened to the body 8 and which has a segment 25 that can exert a return force, generated by the loaded flexible element, on the pin 28 comprised in the anti-bounce part 20, in a tangential direction relative to the second axis of rotation 22 and thereby rotate the anti-bounce part towards the tangential direction. The body 8 comprises a second stop 30 which is arranged so as to be able to stop the rotation of the anti-bounce part towards the tangential direction, in said first position (FIG. 1) or, alternatively, in said second position of the anti-bounce part 20. Preferably, the flexible element 24 is arranged so that the segment 25 exerts the return force on the pin 28 to move the anti-bounce part back into the first position or alternatively into the second position, defined by the second stop, and also when the anti-bounce part is in this first position (FIG. 1), respectively in the second position, so as to have a first or second position which is relatively stable.

In a third particular variant encompassed by the second main variant and shown in FIG. 8, said segment 25 is a first segment and said return force is a first return force. The anti-bounce device 5c comprises a flexible element 24c with a second segment 25a which can exert a second return force on the pin 28 in a second tangential direction, opposite said tangential direction, and thereby rotate the anti-bounce part 20 towards the second tangential direction, the body 8 of the hammer 6c comprising a third stop 31 which is arranged so as to be able to stop a rotation of the anti-bounce part, in said second tangential direction, in said second position (FIG. 8), respectively in said first position of the anti-bounce part. Preferably, the flexible element 24c is arranged so that the second segment 25a exerts the second return force on the pin to move the anti-bounce part back into the second position or the first position, defined by the third stop, and also when the anti-bounce part is in this second position, respectively in this first position.

An advantageous variant of the first embodiment combines the aforementioned first and second main variants and encompasses the variant shown in FIG. 1. The flexible part 24 has a segment 25 for exerting a return force, generated by this loaded flexible part, on the pin 28 in a tangential direction relative to the second axis of rotation 22, the body 8 comprising a second stop 30 that is arranged so as to be able to stop a rotation of the anti-bounce part 20, towards said tangential direction, in said first position of this anti-bounce part when the recess 26 defines the second position (FIG. 1), alternatively in said second position when the recess defines said first position. Preferably, the flexible element 24 is arranged such that the segment 25 continues to exert the return force on the pin 28 when the anti-bounce part is in said first position, respectively in said second position. In this case, said first position, respectively said second position is a stable position for the anti-bounce part. Otherwise, said segment and the second stop define said first range of positions, respectively said second range of positions for the anti-bounce part. In the variant shown, the second stop 30 defines the first position of the anti-bounce part 20, given that the recess 26 defines the second position of this anti-bounce part, the first and second positions being stable positions.

In a preferred variant of the first embodiment and also of the second embodiment which will be subsequently described, the anti-bounce part 20 has a centre of mass C_{M} which is at a distance from the second axis of rotation 22, and it has a protruding part 21 defining a contact surface 21a with the first stop 33, this contact surface being configured to stop the body 8 of the hammer 6 when the hammer is in the first configuration during said rotation in said first direction starting at least at the first intermediate position, by coming up against the first stop 33, before the striking beak touches the gong 10, and to keep the body in the lock position when the hammer is locked.

Returning now to the advantageous variant shown in FIG. 1, some particular characteristics of this variant will be described with reference to FIGS. 1 and 2a to 2h. The first stop 33 is mobile, as it is carried by a flexible blade 32 and configured such that it can retract momentarily, during the return movement of the body 8 during the only partial bounce after a strike, under the action of the anti-bounce part 20 that presses momentarily against the first stop (FIG. 2e). A pin 34, fastened in the plate 3, keeps the flexible blade 32 in a specific position when no force is exerted thereon. Preferably, the flexible blade is slightly stressed when it is pressing against the pin 34. The first stop 33 is formed in this example by a terminal segment of the flexible blade after a bend located on the side of its free end, this terminal segment preferably having an angle with a substantially straight part that is smaller than 90°. When the hammer 6 is locked, as shown in FIG. 1, the hammer body 8 is in its lock position and the anti-bounce part 20 is in said first position, this anti-bounce part then presses against the stop 30 that defines this first position.

According to a first main characteristic of the first embodiment, the anti-bounce device 5 is arranged such that the shift of the anti-bounce part 20 from said first position or first range of positions (anti-bounce device in its first configuration, which corresponds to a first configuration of the hammer 6 in the variant shown) to said second position or second range of positions (anti-bounce device in its second configuration, which corresponds to a second configuration of the hammer 6 in the variant shown) occurs, when the hammer is being wound by the actuating mechanism, when said body is rotated between a maximum position for said return movement and the end position. In the variant shown, the anti-bounce part 20 shifts from the first position (stable position defined by the segment 25 of the wire spring 24 and the pin 30 defining the second stop) to the second position (stable position defined by the V-shaped recess 26 formed by the terminal part of the wire spring 24) in a terminal phase of the winding of the hammer in which the protruding part 21 of the anti-bounce part 20 comes up against a pin 38 fastened in the plate 3 and is then subjected to a force couple, in the opposite direction to the force couple to which the body 8 is subjected when the hammer is winding, which enables this anti-bounce part to overcome the force couple generated by the return force exerted by the segment 25 of the flexible element 24 on the anti-bounce part and thus to move from the first position to the second position, as shown in FIG. 2a.

Once the hammer 6 is completely wound with the anti-bounce part essentially brought into the second stable position, the hammer is released and subjected to a driving force F_{E} from the drive spring 12, which presses against the pin 16 on the hammer body 8. The hammer 6 accelerates until it reaches the gong 10 with a relatively high level of kinetic energy and transmits part of this energy, preferably most of it, to the gong to excite it and allow it to vibrate, emitting the desired sound. In the second position, the hammer 6 is neither stopped nor braked between the end position, in which the hammer is completely wound, and the contact position in which the beak 9 touches the gong 10, shown in FIG. 2c. This is remarkable and highly advantageous. As can be seen in FIG. 2b, the hammer 6, in particular its body 8, is neither disrupted nor braked when the protruding part 21 of the anti-bounce part 20 moves to the first stop 33, while the hammer body is rotated towards the gong (defining a first direction of rotation) and the anti-bounce part is in its second position and the anti-bounce device is thus in its second configuration. The anti-bounce part does not touch the first stop 33 during this rotation between the end position of the body and the contact position with the gong. FIG. 2b shows the hammer body 6 substantially in an intermediate position, previously referred to as the “second intermediate position,” in which it is generally provided, in the main embodiment, that the anti-bounce part is at the latest in its second position, and thus the anti-bounce device in its second configuration, to avoid contact with the first stop.

According to a second main characteristic of the first embodiment, the shift of the anti-bounce part from said second position or second range of positions to said first position or first range of positions is released by the strike of the gong by the hammer body, more specifically by the striking beak 9 (as shown in FIG. 2c). The anti-bounce part is arranged such that, in the second position or second range of positions, its centre of mass C_{M} is at a distance from a geometric straight line running through the second axis of rotation 22 and orthogonal to a straight line connecting the first axis of rotation 14 and the second axis of rotation, the anti-bounce part 20 being subjected to an apparent force couple relative to the body 8, previously referred to as the ‘second apparent force couple,’ generated by an apparent force F_{A} at the centre of mass C_{M} due to a reaction force F_{R} produced by the gong 10, to which the body 8 and thereby the anti-bounce part is subjected at the level of the second axis of rotation 22, when the striking beak 9 comes up against the gong. The anti-bounce device is arranged such that the apparent second force couple rotates the anti-bounce part (FIG. 2c) to the first position (FIG. 2d) or first range of positions (in another variant), in which it remains during the return movement of the body (FIGS. 2d to 2f) that occurs directly after the strike. A corollary of the second main characteristic is as follows: The anti-bounce part 20 remains in the first position during the return movement that occurs during the single bounce following a strike, which is partial. It should be noted that the apparent force couple to which the anti-bounce part is subjected is relatively intense. The anti-bounce part 20 thus shifts from said second position to said first position almost instantaneously with the strike (FIG. 2d), as the anti-bounce part can come up against the stop 30 at high angular velocity, which dissipates enough energy from the anti-bounce part 20 to keep it from returning to its second position.

As already indicated, when the body 8 is returning during the single partial bounce after a strike, the stop 33, carried by the flexible blade 32, momentarily retracts under the action of the anti-bounce part 20, which presses laterally against this stop (FIG. 2e). The return movement continues until the protruding part 21 of the anti-bounce part has moved beyond the stop 33, in a second direction of rotation opposite to said first direction of rotation, to reach a maximum position (FIG. 2f) which is located at least at a first intermediate position of the body 8 (FIG. 2g) from which a rotational movement of the body 8 in said first direction of rotation back towards the gong 10, while the anti-bounce part is still in its first position and the anti-bounce device is therefore in its first configuration, is stopped by the stop 33 before the striking beak 9 has been able to touch the gong, whether or not the gong is vibrating. The striking device and more specifically the anti-bounce device 5 are arranged such that, during said return movement, the body 8 of the hammer reaches at least said first intermediate position, from which the hammer is stopped during a rotation in said first direction when the anti-bounce part 20 is in the first position, without, however, reaching the end position. To this end, in particular, the residual energy retained by the hammer after a strike is adjusted. Preferably, to achieve a certain degree of functional security, the anti-bounce device is arranged such that the return movement reaches a maximum position (FIG. 2f) located above said first intermediate position. It will be noted that, in the first main embodiment, the second intermediate position of the body 8 is different from the first intermediate position of this body (substantially represented in FIG. 2g), the second intermediate position corresponding to a second angular position of the body which is further from said contact position of the body (FIG. 2c) than the first intermediate position, which corresponds to a first angular position of the body.

After a short stabilisation period, the hammer is again locked (FIG. 2h), unless the hammer actuating mechanism has resumed loading the hammer for the next strike before the hammer is fully locked. It should be noted that the first stop is carried by a flexible element and, in the variant shown, it itself has a degree of flexibility, particularly in the angular direction relative to the first axis of rotation 14. In this way, the anti-bounce device 5 is arranged, in particular the lock position provided for the body 8 is chosen such that, despite the resilient nature of the stop 33 and of its support 32, the striking beak 9 cannot come into contact with the gong 10 when it is in a vibrating state, and therefore a fortiori in a non-excited/non-vibrating state.

It should be noted that, in other embodiments, only the first main characteristic or only the second main characteristic described above is foreseen.

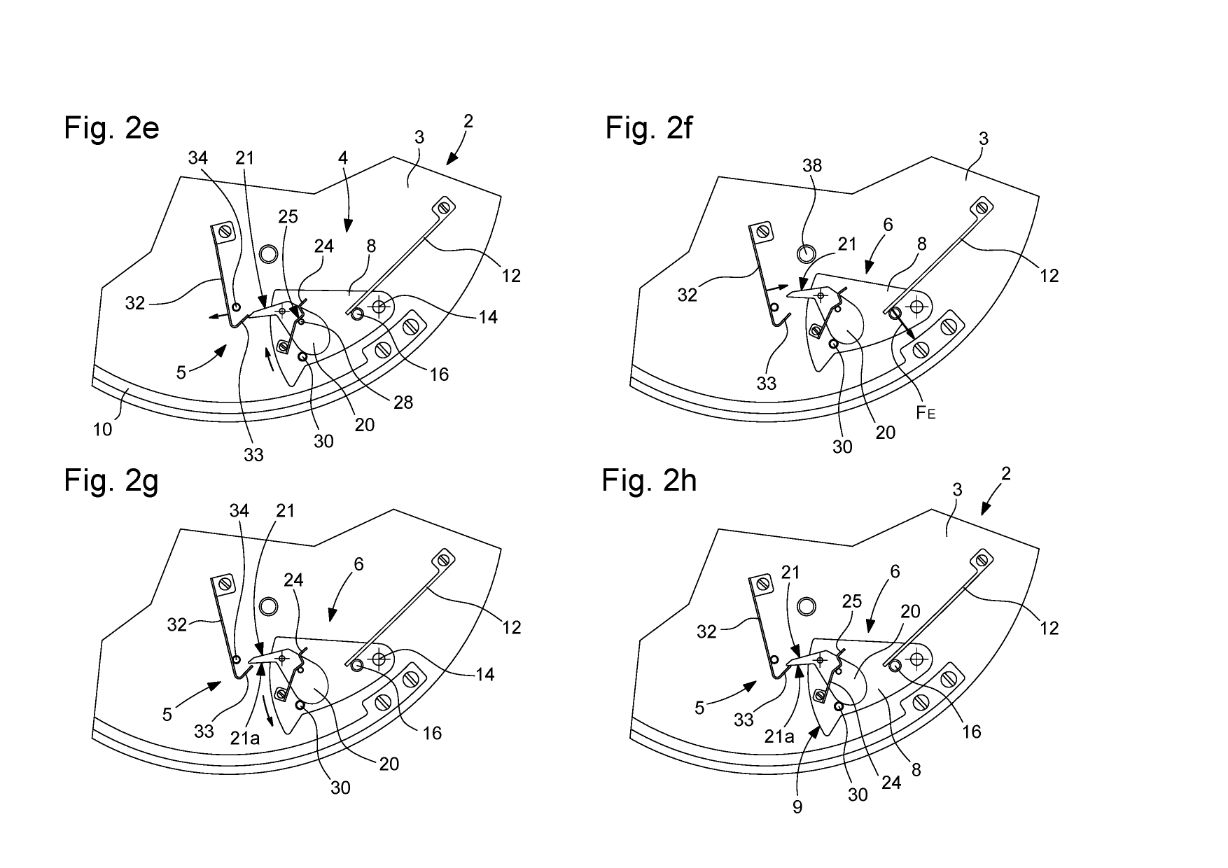

With reference to FIGS. 3 to 5, a second embodiment of a horology movement according to the invention will be described hereinafter. Essentially, only the differences with the first embodiment will be described, without repeating in detail the elements common to the two embodiments, both of which are encompassed in the main embodiment described above.

The movement 42 comprises a striking device 44 that differs from the striking device 4 already described, in the arrangement of the anti-bounce device 45 and its function. The general function remains the same, in particular because the anti-bounce device keeps the hammer from making a complete bounce after a strike and from coming into contact with the gong again before a new strike is made in a controlled manner by the striking device.

The anti-bounce device 45, which forms the striking device 44, comprises an anti-bounce part 20a, fitted to the body 8 of the hammer 7, that is similar to the anti-bounce part 20 of the first embodiment, the only difference being the positioning of the pin 28, which forms a bearing part for a flexible blade 48 fastened to the body 8 of this anti-bounce part and forming said flexible element of the main embodiment. The anti-bounce part 20a thus has a centre of mass C_{M} that is at a distance from the second axis of rotation 22 and it has a protruding part 21 defining a contact surface 21a with a first stop 46. This first stop 46 is rigidly fitted to the plate 3. The stop 46 is attached to the plate, which forms a support for the striking device, in particular for the hammer. Thus, in the second embodiment, the shift of the anti-bounce part 20a from the second position to the first position, as defined above, cannot be released by the strike and occurs during this strike or directly thereafter. It should be noted that the shift in question relates, as previously defined, to a transition between the second configuration and the first configuration of the anti-bounce device 45, after which the anti-bounce device remains in the first configuration until the hammer is stopped by the first stop 46, during the only partial bounce following each strike, in a movement of said body towards the gong defining a first direction of rotation for this body of the hammer. Thus, during the shift in question, the anti-bounce device is returned to the first configuration and then remains in this first configuration until the hammer is again locked or wound by the actuating mechanism.

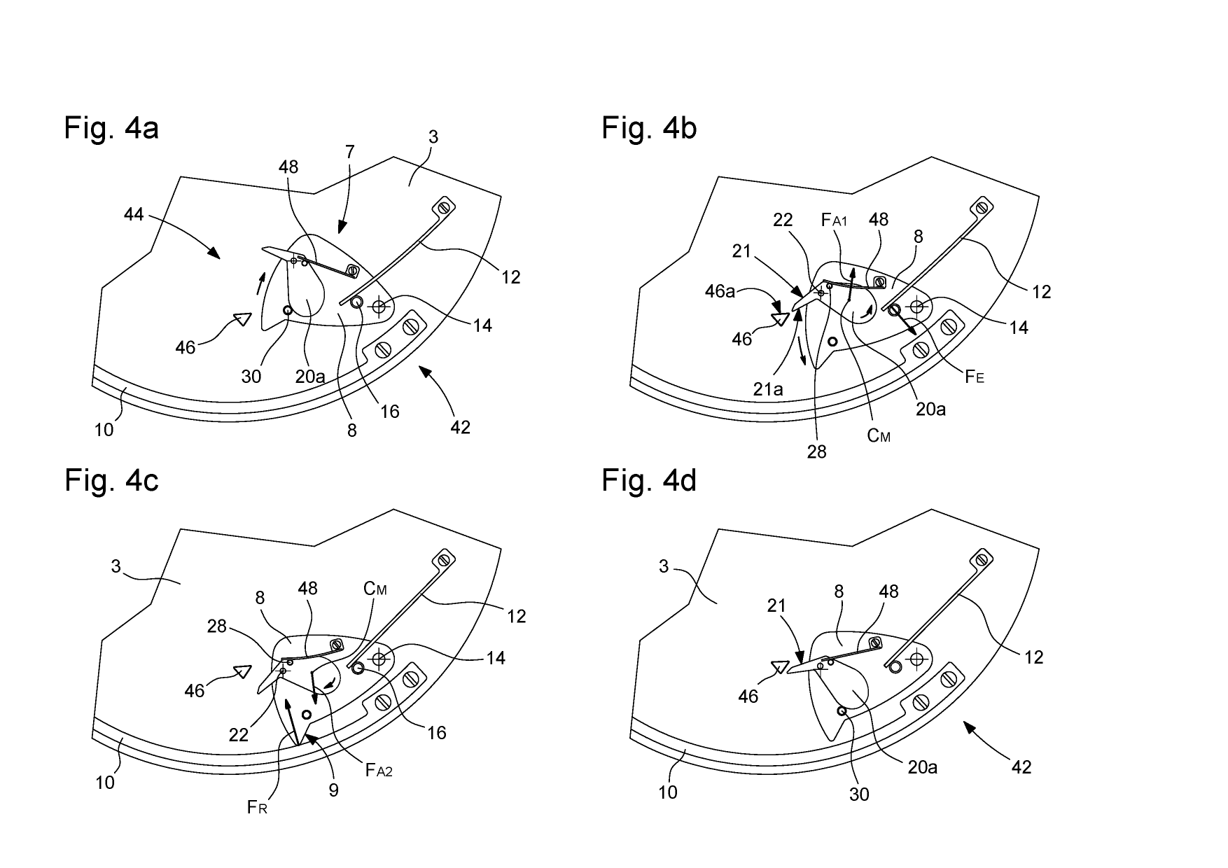

According to a first particular characteristic of the second embodiment, the anti-bounce device 45 does not define a stable position for said second position of the anti-bounce part. Indeed, as will be explained below with reference to FIGS. 4a to 4g, the anti-bounce part shifts dynamically from said first position to said second range of positions, which substantially has a limit position defined by the stiffness of the flexible blade or optionally by a limiting stop (for example the part fastening the flexible blade 48 to the plate 3), and then returns to the first range of positions at the latest during the strike. According to a second particular characteristic of the second embodiment, due to the first stop 46 fixedly arranged on the plate 3, the aforementioned shift of the anti-bounce part 20a from said second position or second range of positions to said first position or first range of positions occurs during said return movement after the body 8 has moved beyond said first intermediate position (FIG. 4f).

FIG. 3 shows the striking device 44 inactive with the locked hammer 7, the hammer body 8 thus being in the lock position corresponding to the first position. The body 8 is kept in the lock position by the first stop 46 retaining the protruding part 21, the contact surface 21a of which presses against an upper surface 46a of this first stop, while the body 8 remains subjected to a force from the drive spring 12 that keeps the anti-bounce part 20a pressed against the second stop 30, which defines said first position of this anti-bounce part. Moreover, the flexible blade 48 presses lightly against the pin 28, which helps position the anti-bounce part in said first position. FIG. 4a shows the hammer 7 in a wound state, with its body in the end position P_{E}. It should be noted that, unlike the first embodiment, the anti-bounce part 20a is still in its first position, in which it is held by the flexible blade 48 exerting a slight return force on the pin 28.

According to a main characteristic of the second embodiment, the anti-bounce device 45 is arranged so that the shift of the anti-bounce part 20a from the first position or first range of positions to the second position or second range of positions occurs after the hammer is released and before the body 8 reaches the second intermediate position (FIG. 4b), namely, between FIG. 4a and FIG. 4b. Said shift results from the fact that the body 8 of the hammer 7 is subjected to an intense acceleration generated by the driving force F_{E} applied by the spring 12 to the pin 16 fastened to the body 8 of the hammer in order to generate a strike on the gong. This intense acceleration is transmitted to a material axis that is fastened to said body and defines the second axis of rotation 22. In other words, the anti-bounce part 20a is fitted so as to be rotationally mobile around this material axis which, together with the body 8, is subjected to intense acceleration as soon as the hammer is released by the actuating mechanism. This acceleration generates an apparent force F_{A1} on the anti-bounce part 20a at its centre of mass C_{M}, which is at a distance from the second axis of rotation. Indeed, the anti-bounce part 20a is arranged such that, in the first position or first range of positions, the centre of mass CM is at a distance from a geometric straight line running through the second axis of rotation and orthogonal to a straight line connecting the first axis of rotation 14 and the second axis of rotation 22, the anti-bounce part being subjected, relative to the body 8, to an apparent force couple due to said intense acceleration to which this body is subjected, and thus the anti-bounce part at the second axis of rotation.

The anti-bounce device 45 is remarkably designed, in particular the resilience of the flexible blade 48, the anti-bounce part and the position of the pin 28, such that said apparent force couple rotates the anti-bounce part 20a to the second position or, in the variant shown, to the second range of positions, and then this anti-bounce part remains in the second position or in this second range of positions at least until the end of the contact surface 21a of the anti-bounce part moves beyond a contact surface 46a on the first stop 46 when the body 8 is rotated between the end position P_{E} and the contact position P_{F} to perform a strike. The apparent force couple, resulting from the apparent force F_{A1}, acts against the return force couple, generated by the return force from the flexible blade 48 on the pin 28, which tends to return the anti-bounce part towards the stop 30 defining the first position of the anti-bounce part 20a. In this way, the return force couple increases as the anti-bounce part rotates from its first position, gradually opposing the apparent force couple.

At the latest when the striking beak 9 reaches the gong 10 (FIG. 4c), the anti-bounce part returns to the first range of positions and strikes hard against the second stop 30 during the strike (FIG. 4d), which generates a strong apparent force couple on the anti-bounce part generated by an apparent force F_{A2}, which results from the reaction force F_{R} from the gong on the body 8 of the hammer and therefore on the material axis around which the anti-bounce part 20a is fitted, as already explained. Very advantageously, the hammer 7 is neither stopped nor braked between the end position, in which the hammer is wound, and the contact position, where the beak 9 reaches the gong 10. This is a remarkable result of the invention.

Generally speaking, the first apparent force couple to which the anti-bounce part is subjected opposes a force couple resulting from said return force from the flexible element (flexible blade 48), the flexible element being arranged such that the return force can return the anti-bounce part to said first position or range of positions only after the end of the contact surface 21a of the anti-bounce part 20a has moved beyond the stop surface 46a on the first stop 46 when the body 8 is rotated between the end position and the contact position and before the body of the hammer reaches, on said return movement, a maximum position for that return movement.

In the particular variant shown in the figures, given that the first stop 46 is fixed and that the first position of the anti-bounce part is also not very stable if no outer force is exerted on the hammer (because the anti-bounce part is kept against the pin 30 only by the flexible blade 48 which exerts a slight force on the anti-bounce part in its first position), said shift from the second configuration of the anti-bounce device to the first configuration, in which it then remains until the protruding part 21 of the anti-bounce part 20a comes up against the first stop 46, occurs only during the return movement, after the strike, as soon as the body 8 has reached said first intermediate position (FIG. 4f) or immediately thereafter. During the return movement, as it moves past the stop 46, the protruding part 21 of the anti-bounce part may come into contact with this stop (FIG. 4e) and then be subjected to a rotational movement, braked by the return force from the flexible blade 48, to reach the second range of positions again, for a brief moment, so as to be able to reach at least said first intermediate position. The stop 46 is configured to enable the aforementioned rotational movement of the anti-bounce part without stopping the return movement of the body 8, in particular without keeping it from reaching at least the first intermediate position.

It should be noted that in the second embodiment, having a fixed stop 46 results in the first intermediate position and the second intermediate position both corresponding substantially to the same angular position of the body 8 of the hammer.

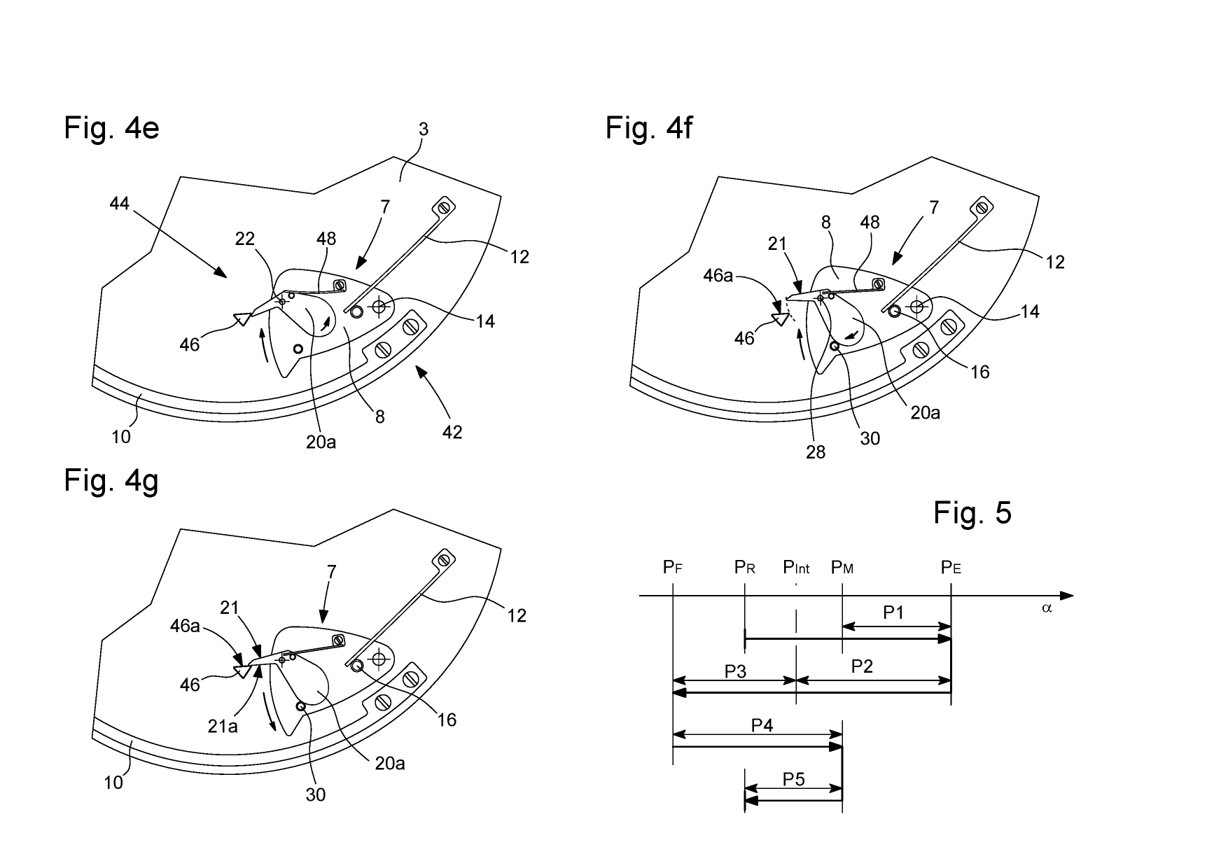

In FIG. 5, considering the particular case of a same intermediate position P_{Int} for the first and second intermediate positions (to simplify the diagram), the process of generating a sound by the striking device according to the invention is summarised, that is to say, the process by which the gong is struck by the hammer from a state in which the hammer is locked until the hammer has returned to this locked state. The hammer is wound by the actuating mechanism from the lock position P_{R} to the end position P_{E} of the body, thereby being rotated in said second direction. The hammer is then released and its body rotated in said first direction of rotation, accelerating under the action of the driving force F_{E} exerted by the drive spring, towards the gong until the striking beak contacts the gong at a striking/contact position P_{F} of the body. There is a second phase P2 in this rotation in the first direction of rotation, between the end position P_{E} and the intermediate position P_{Int}.

According to the invention, the anti-bounce device shifts from said first configuration to said second configuration in phases P1 and P2, more specifically either in a first phase P1 between the maximum position P_{M} of said return movement of the body 8 after a strike and the end position P_{E}, or in said second phase P2. When rotating in the first direction from the end position P_{E} of said body, the hammer is not stopped and it is not braked in its rotational movement in the second direction at least during a third phase P3 directly following the second phase P2 and ending when said body reaches the strike/contact position P_{F}. Preferably, the hammer is not braked in the rotational movement of its body in the first direction between the end position and the strike/contact position.

After the strike, the body 8 of the hammer is subjected to a return movement, namely a rotation in said second direction of rotation, up to the maximum position P_{M}, this return movement defining a fourth phase P4 of the process in which the gong is struck by the hammer. In a preferred main variant, the anti-bounce device shifts from said second configuration to said first configuration in the fourth phase P4, and then remains in that first configuration during a subsequent fifth phase P5 in which the body is subjected to a terminal rotation in the first direction (towards the gong) from the maximum position P_{M} to the lock position P_{R}. At the end of any short terminal stabilisation phase (damping of the rotational movement of the anti-bounce part), the hammer is again locked (FIGS. 2h and 4g). In a particular variant, it can be foreseen that the shift of the anti-bounce device from the second configuration to the first configuration already occurs in the third phase, P3, after one end of the contact surface 21a of the anti-bounce part has moved beyond a stop surface on the stop.

1. A movement (2, 42) incorporating a striking device (4, 44) comprising a gong (10), a hammer (6, 6a, 6b, 6c, 7) rotationally mobile around a first axis of rotation (14) and a spring (12) for rotationally driving the hammer, the hammer having a body (8) with a striking beak (9) arranged in a zone at a distance from the first axis of rotation, the drive spring being arranged to be able to apply a driving force to the body of the hammer so as to cause it to rotate in a first direction that brings the striking beak closer to the gong and allows the striking beak to strike the gong, the striking device (4, 44) comprising a hammer actuating mechanism for winding the hammer from a lock position of the body of the hammer, in which the striking beak is separated from the gong, by rotating this body in a second direction, opposite to the first direction, to an end position of said body, so as to load the drive spring, and then to release the hammer so that it can strike the gong under the action of the driving force; wherein the striking device comprises an anti-bounce device (5, 5a, 5b, 5c, 45) which is arranged so that it can be alternately:
in a first configuration, in which the anti-bounce device stops the body of the hammer from moving in the first direction of rotation, starting at least at a first intermediate position between the lock position and the end position of this body, before the striking beak can touch the gong, whether the latter is vibrating or not; and
in a second configuration, different from the first configuration, in which the anti-bounce device does not stop the hammer from rotating in the first direction of rotation between the end position of said body and a contact position, at which the striking beak reaches the gong, provided that the anti-bounce device is in this second configuration when the body shifts through a second intermediate position between the lock position and the end position; the anti-bounce device does not brake the body of the hammer at least between the second intermediate position and the contact position, preferably between the end position and the contact position;
wherein the striking device is arranged such that, after each strike, the body of the hammer is subjected to a return movement, rising at least to the first intermediate position without reaching the end position; and wherein the striking device is arranged such that the anti-bounce device is:
kept in the first configuration when the hammer is locked and said body is therefore in the lock position;
brought into the second configuration, each time the hammer is wound by the actuating mechanism or after the hammer is released before the body (8) of this hammer reaches the second intermediate position;
then returned to the first configuration during said return movement of said body; and
then remains in the first configuration until the hammer is locked again or wound again by the actuating mechanism;
said body thus being subjected to a single, partial bounce after each strike.

2. The movement according to claim 1, wherein the anti-bounce device comprises an anti-bounce part (20, 20a), fitted so as to be rotationally mobile on the body (8) of the hammer (6, 6a, 6b, 6c, 7) around a second axis of rotation (22), and a first stop (33, 46) fitted on a support (3) of the hammer and arranged such that
when the anti-bounce part is, when said body shifts through the second intermediate position, in a second position or second range of positions relative to the body of the hammer and the anti-bounce device is thus in the second configuration, the anti-bounce part (20, 20a) does not contact the first stop (33, 46) when said body (8) rotates between the end position and the contact position;
when the anti-bounce part is in a first position or first range of positions relative to the body of the hammer and the anti-bounce device (5, 5a, 5b, 5c, 45) is thus in the first configuration, the body of the hammer is stopped by the anti-bounce part coming up against the first stop (33, 46) when rotating in said first direction starting at least at the first intermediate position and below the end position; and
when the hammer is locked, the anti-bounce part presses against the first stop.

3. The movement according to claim 2, wherein the anti-bounce device (5, 5a, 5b) comprises a flexible element (24, 24a, 24b) which is fastened to said body (8) and which comprises a portion with a recess (26, 27, 27a) having a non-tangential orientation relative to the second axis of rotation (22), preferably angularly closer to a radial straight line running through a point at the back of the recess than to a tangential straight line running through this point, this recess defining a stable position for the anti-bounce part (20) which comprises a support part (28), against which the flexible element can press, and arranged so that it can be turned in at least partially in the recess substantially without slack when this anti-bounce part is in said stable position, and so that it can elastically move said portion of the flexible element under the action of a force couple to which the anti-bounce part may be subjected, to exit the recess, the anti-bounce part being in said first position or said second position when it is in said stable position defined by the recess of the flexible element, said portion of the flexible element being configured so that, when the recess defines the first position, the anti-bounce part (20) can be actuated in the second position or second range of positions by said force couple and, when the recess defines the second position, the anti-bounce part can be actuated in the first position or first range of positions by said force couple.

4. The movement according to claim 3, wherein said recess (27a) is configured such that it has a flank (27b) forming a stop for the support part (28) in a direction of rotation of the anti-bounce part (20) which is opposite to the direction of rotation allowing the anti-bounce part to be brought into the second position or second range of positions, respectively into the first position or first range of positions.

5. The movement according to claim 3, in which said portion of the flexible element is a first portion and said recess (26) is a first recess; wherein the flexible element (24a, 24b) comprises a second portion defining a second recess (27, 27a) having a non-tangential orientation relative to the second axis of rotation, preferably angularly closer to a radial straight line running through a point at the back of the second recess than to a tangential straight line running through that point, this second recess defining a second stable position for the anti-bounce part, the flexible element being arranged such that the support part can be turned in at least partially in the second recess, substantially without slack when this anti-bounce part is in the second stable position, and can elastically move the second portion of the flexible element under the action of a second force couple, opposite to said force couple, to which the anti-bounce part may be subjected in order to exit the second recess, the first recess defining said first position of the anti-bounce part and the second recess defining said second position of this anti-bounce part when the support part is turned in alternately in the first recess and in the second recess, the second portion of the flexible element being configured such that the anti-bounce part can be brought into the first position under the action of said second force couple.

6. The movement according to claim 2, wherein the anti-bounce device comprises a flexible element (24, 48) which is fastened to said body and which has a segment (25, 25a) which can exert a return force, generated by the stressed flexible element, on a support part (28) comprised by the anti-bounce part (20, 20a), in a tangential direction relative to the second axis of rotation (22) and thus rotate the anti-bounce part towards the tangential direction, said body comprising a second stop (30, 31) which is arranged so as to be able to stop the rotation of the anti-bounce part, in said tangential direction, in said first position or in said second position of the anti-bounce part.

7. The movement according to claim 6, wherein the flexible element (24, 48) is arranged so that said segment (25, 25a) exerts the return force on the support part (28) to return the anti-bounce part to the first position or the second position, defined by the second stop, and also when the anti-bounce part is in this first position, respectively in this second position.

8. The movement according to claim 6, in which said segment (25) is a first segment and said return force is a first return force; wherein the flexible element (24c) has a second segment (25a) which can exert a second return force on the support part (28) in a second tangential direction, opposite to said tangential direction, and thus rotate the anti-bounce part (20) towards the second tangential direction, said body comprising a third stop (31) which is arranged so as to be able to stop the rotation of the anti-bounce part, in said second tangential direction, in said second position, respectively in said first position of the anti-bounce part.

9. The movement according to claim 8, wherein the flexible element (24c) is arranged so that the second segment (25a) exerts the second return force on the support part to return the anti-bounce part to the second position or the first position, defined by the third stop (31), and also when the anti-bounce part is in this second position, respectively in this first position.

10. The movement according to claim 3, wherein said flexible element (24) has a segment (25) which can exert a return force, generated by the stressed flexible element, on the support part (28) in a tangential direction relative to the second axis of rotation (22), said body comprising a second stop (30) which is arranged so as to be able to stop the rotation of the anti-bounce part (20), towards said tangential direction, in said second position of the anti-bounce part, when said recess (26) defines said first position, or in the first position when the recess defines the second position.

11. The movement according to claim 10, wherein the flexible element (24) is arranged so that the segment (25) continues to exert the return force on the support part (28) when the anti-bounce part (20) is in the second position, respectively in the first position.

12. The movement according to claim 10, wherein said recess (26) defines said second position and the second stop (30) defines the first position.

13. The movement according to claim 2, wherein the anti-bounce device (5) is arranged such that a shift of the anti-bounce part (20) from said first position or range of positions to said second position or range of positions occurs while the hammer (6) is being wound by the actuating mechanism, when said body (8) rotates between a maximum position for said return movement and said end position.

14. The movement according to claim 2, wherein the anti-bounce part (20, 20a) has a centre of mass (C_{M}), which is at a distance from the second axis of rotation (22), and has a contact surface (21a) with the first stop (33, 46), this contact surface being configured to stop the body (8) of the hammer (6), 6a, 6b, 6c, 7), when the anti-bounce device (20) is in said first configuration, during said rotation in said first direction, from at least the first intermediate position, by coming up against the first stop and to keep said body in the lock position when the hammer is locked.

15. The movement according to claim 14, wherein the anti-bounce device (45) is arranged so that a shift of the anti-bounce part (20a) from said first position or first range of positions to said second position or second range of positions occurs after the hammer (7) has been released and before said body (8) reaches the second intermediate position, the anti-bounce part being arranged such that, in the first position or first range of positions, said centre of mass is at a distance from a geometric straight line running through the second axis of rotation (22) and orthogonal to a straight line connecting the first axis of rotation (14) and the second axis of rotation, the anti-bounce part being subjected, relative to said body, to a first apparent force couple due to an acceleration to which the body is subjected, and thus the anti-bounce part at the second axis of rotation, generated by said driving force applied to this body by the drive spring (12), the anti-bounce device being arranged such that the first apparent force couple causes the anti-bounce part to rotate to the second position or second range of positions and remains in this second position or second range of positions until one end of said contact surface (21a) of the anti-bounce part has moved beyond a stop surface (46a) on the first stop (46) during said rotation of said body (8) between said end position and said contact position.

16. The movement according to claim 15, wherein the anti-bounce device comprises a flexible element (24, 48) which is fastened to said body and which has a segment (25, 25a) which can exert a return force, generated by the stressed flexible element, on a support part (28) comprised by the anti-bounce part (20, 20a), in a tangential direction relative to the second axis of rotation (22) and thus rotate the anti-bounce part towards the tangential direction, said body comprising a second stop (30, 31) which is arranged so as to be able to stop the rotation of the anti-bounce part, in said tangential direction, in said first position or in said second position of the anti-bounce part ; and wherein the second stop (30) defines the first position of the anti-bounce part (20a); and wherein the first apparent force couple to which the anti-bounce part is subjected opposes a force couple resulting from said return force, the flexible element (48) being arranged such that the return force can return the anti-bounce part to said first position or first range of positions only after one end of the contact surface (21a) of the anti-bounce part has moved, during said rotation of said body between the end position and the contact position, beyond a stop surface (46a) on the first stop (46) and before the body (8) of the hammer (7) reaches, during said return movement, a maximum position for this return movement.

17. The movement according to claim 14, wherein a shift of the anti-bounce part (20) from said second position or second range of positions to said first position or first range of positions, in which it then remains until the end of said single partial bounce, is released by the strike of the gong by the body (8) of the hammer, the anti-bounce part being arranged such that, in the second position or second range of positions, said centre of mass is at a distance from a geometric straight line running through the second axis of rotation (22) and orthogonal to a straight line connecting the first axis of rotation (14) and the second axis of rotation, the anti-bounce part being subjected relative to said body to a second apparent force couple due to a reaction force from the gong to which that body is subjected, and thus the anti-bounce part at the second axis of rotation, when the striking beak (9) stops against the gong (10), the anti-bounce device being arranged such that the second apparent force couple causes the anti-bounce part to rotate to the first position or range of positions in which it remains during said return movement of said body.

18. The movement according to claim 17, wherein the first stop (33) is carried by a flexible blade (32) and configured so that it can retract momentarily during said return movement of said body (8) in said second direction of rotation, under the action of the anti-bounce part (20) which presses momentarily against the first stop.

19. The movement according to claim 2, wherein the first stop (46) is fixed, and wherein a shift of the anti-bounce part (20a) from said second position or second range of positions to said first position or first range of positions, in which it then remains until the end of said single partial bounce, occurs during said return movement as soon as said body (8) has reached or moved beyond the first intermediate position.
